(19) United States
(12) Patent Application Publication
(10) Pub. No.: US 2017/0166069 A1
(43) Pub. Date: Jun. 15, 2017

(54) ELECTRIC POWER SUPPLY SYSTEM

(71) Applicant: Toyota Jidosha Kabushiki Kaisha, Toyota-shi Aichi-ken (JP)

(72) Inventor: Yuki Jojima, Nagoya-shi Aichi-ken (JP)

(21) Appl. No.: 15/369,206

(22) Filed: Dec. 5, 2016

(30) Foreign Application Priority Data
Dec. 14, 2015 (JP) 2015-243499

(51) Int. Cl. B60L 11/18; H02M 1/14; H02P 27/08; H02M 7/44

(52) U.S. Cl. CPC B60L 11/1814; H02M 7/44; H02M 1/14; H02P 27/08; B60L 11/1803; B60L 2210/40

(57) ABSTRACT

Disclosed herein is an electric power supply system in which two or more power converters are connected in parallel between a battery and a load apparatus, in which a battery temperature is increased rapidly in cases where the battery temperature is low. An electric power supply system 2 includes a battery 3, two voltage converters 10a, 10b, and a controller 9. The two voltage converters 10a, 10b are connected in parallel. The controller 9 supplies drive signals having a same waveform to transistors of the power converters 10a, 10b. When a temperature of the battery 3 is lower than a predetermined threshold temperature, the controller 9 supplies to the transistors of the power converters 10a, 10b the drive signals having the same waveform but with a smaller phase difference than in a case where the temperature of the battery 3 is higher than the threshold temperature.

### CROSS-REFERENCE TO RELATED APPLICATION

This application claims priority to Japanese Patent Application No. 2015-243499 filed on Dec. 14, 2015, the contents of which are hereby incorporated by reference into the present application.

### TECHNICAL FIELD

The teaching disclosed herein relates to an electric power supply system configured to supply electric power to a load apparatus. Especially, it relates to an electric power supply system in which a plurality of power converters provided with switching elements are connected in parallel between a battery and the load apparatus.

### BACKGROUND ART

An electric power supply system that connects power converters provided with switching elements in parallel is known. For example, Japanese Patent Application Publication No. 2012-210138 discloses an electric power supply system configured to connect a plurality of voltage converters provided with switching elements in parallel to a battery, and supply an output of the plurality of voltage converters to an inverter. The switching elements generate ripples according to their switching operations. In Japanese Patent Application Publication No. 2012-210138, phases of the operations of the switching elements of the plurality of voltage converters are offset to avoid overlaps of the ripples, and attempts to prevent a noise increase by the overlapped ripples.

### SUMMARY

On the other hand, ripples may be used for increasing a temperature of a battery. The battery may not exhibit sufficient performance when its temperature is low, however, when the ripples arrive at the battery, the battery generates heat according to amplitudes of the ripples, and the temperature of the battery may thereby be increased. However, according to the technique of Japanese Patent Application Publication No. 2012-210138, since the ripples are prevented from overlapping each other by offsetting the phases as described above, the amplitudes of the ripples are small, and there was a problem that the battery temperature cannot be increased sufficiently by the ripples. The teaching herein aims to provide an electric power supply system that can prevent a noise increase by the overlapped ripples while sufficiently increasing a battery temperature when the battery's temperature is low.

An electric power supply system disclosed herein comprises a battery, two or more power converters, a controller, and a temperature sensor. The two or more power converters are connected in parallel between the battery and a load apparatus. Each of the two or more power converters includes a switching element for power conversion, each of which is configured to be electrically connected to the battery. The controller is configured to supply drive signals having a same waveform to the switching element of each of the power converters. Notably, as will be described later, the controller may supply the drive signals having the same waveform but different phases to the switching elements of at least two power converters among the two or more power converters. The temperature sensor measures a temperature of the battery. When the battery temperature is lower than a predetermined threshold temperature, the controller supplies the drive signals having the same waveform but with a smaller phase difference than when the battery temperature is higher than the threshold temperature to the switching elements of the at least two power converters among the two or more power converters. When the phase difference between the drive signals supplied to the switching elements is small, ripples of the at least two power converters become chronologically closer to each other, as a result of which an amplitude of the ripple becomes large and an effect of heating the battery is increased. On the other hand, when the battery temperature is high, the controller supplies the drive signals having the large phase difference to the switching elements of the at least two power converters, thereby cancelling out the ripples generated by the switching elements of the at least two power converters, and noise caused by the ripples is reduced. Notably, for example, the phases of two drive signals being shifted by 90 degrees and the phases being shifted by 270 degrees are equivalent in terms of the relative relationship thereof. In such a case, in this description, the smaller value is employed as the phase difference between the two drive signals.

In an embodiment of the electric power supply system, the controller is configured to: supply the drive signals having the same waveform but different phases to the switching elements when the battery temperature is higher than the threshold temperature; and supply the drive signals having the same waveform and the same phase to the switching elements of the two power converters when the battery temperature is lower than the threshold temperature. Notably, the drive signals having the same waveform and the same phase refer to drive signals that turn on the switching elements at the same timing and turn them off at the same timing as well. The drive signals having the same waveform and different phases refer to drive signals that have the same waveform but differ in the timing to turn on the switching elements and in the timing to turn them off as well.

The electric power supply system of the embodiment as aforementioned synchronizes the operation of the switching elements of at least two power converters when the battery temperature is low. The ripples generated in the switching elements are overlapped and propagated to the battery. The battery generates heat by receiving the overlapped ripple, and the temperature thereof raises quickly. On the other hand, when the battery temperature becomes high, the electric power supply system shifts the phases of the drive signals given to the switching elements of the plurality of power converters. By this phase shifting, the ripples generated in the switching elements of the plurality of power converters are cancelled out, and the noise caused by the ripples can be suppressed.

Notably, in the case where the electric power supply system comprises two power converters, the phase difference between the drive signals to be supplied to the switching elements of the two power converters is 180 degrees at maximum. That is, in the case of the electric power supply system provided with the two power converters, the controller may supply the drive signals having the same waveform with a 180-degree phase difference to the switching elements of the two power converters when the battery temperature is higher than the threshold temperature. The drive signals having the 180-degree phase difference can effectively cancel out the ripples. Details and further improvements to the technique disclosed herein will be described in the below Detailed Description.

### BRIEF DESCRIPTION OF DRAWINGS

FIG. 1 is a block diagram of an electric power system of an electric vehicle including an electric power supply system of an embodiment;

FIG. 2 is a flowchart of a phase control executed by a controller;

FIG. 3 is a time chart showing an example of a battery temperature, drive signals, and ripples; and

FIG. 4 is a time chart in a phase control of a variant.

### DETAILED DESCRIPTION

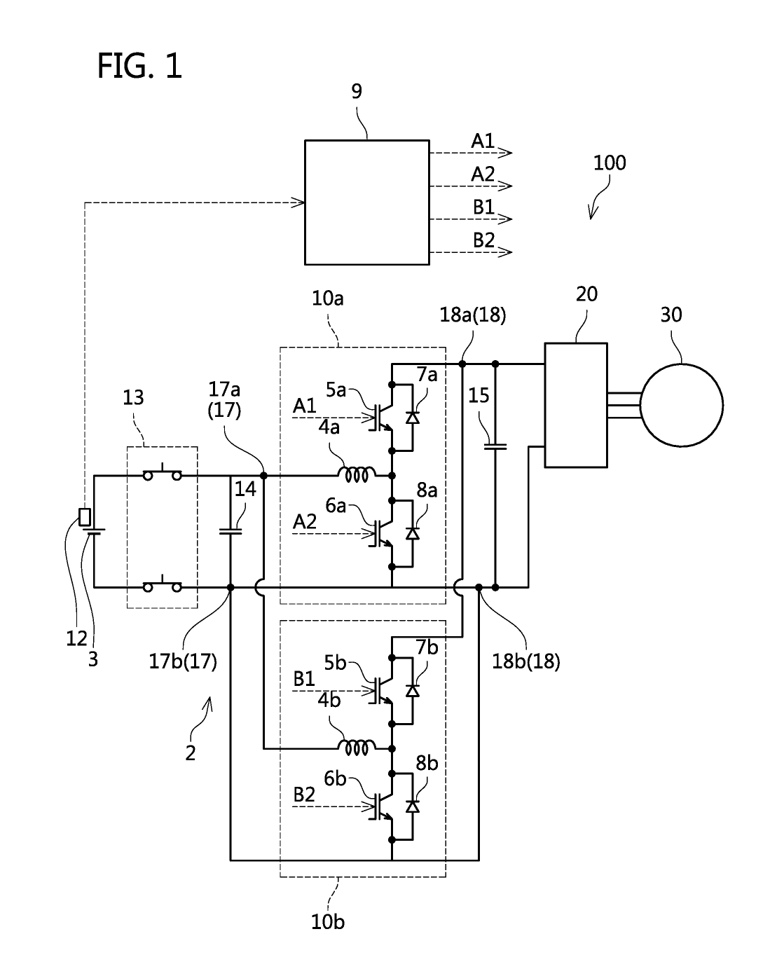

An electric power supply system 2 of an embodiment will be described with reference to the drawings. The electric power supply system 2 is mounted in an electric vehicle. FIG. 1 shows a block diagram of an electric power system of the electric vehicle 100 that includes the electric power supply system 2 of this embodiment. The electric vehicle 100 of this embodiment comprises the electric power supply system 2, an inverter 20, and a traction motor 30. The electric vehicle 100 converts DC power supplied from the electric power supply system 2 to AC power by the inverter 20. The traction motor 30 rotates by the AC power converted by the inverter 20, by which the electric vehicle 100 runs and travels. In the electric vehicle 100, the motor 30 is driven in reverse from an output shaft side when a driver steps on a brake pedal, and the motor 30 generates electric power. An act of the vehicle running by the motor 30 outputting torque will be termed “power running”, and an act of the motor generating electric power by functioning as a generator will be termed “regeneration”. The electric power generated by the regeneration will be termed a regenerated electric power. The regenerated electric power is used to charge a battery 3.

The electric power supply system 2 comprises the battery 3, a temperature sensor 12, a system main relay 13, two voltage converters 10a, 10b, a filtering capacitor 14, a smoothing capacitor 15, and a controller 9. The electric power supply system 2 is a power source that supplies DC power to the inverter 20. The electric power supply system 2 boosts a voltage of electric power of the battery 3 and supplies the same to the inverter 20. The electric power supply system 2 boosts a voltage of the battery 3 by both of the two voltage converters 10a, 10b, and supplies the same to the inverter 20. Notably, each of the voltage converters 10a, 10b can lower a voltage of the regenerated electric power supplied from the inverter 20 and charge the battery 3. That is, the voltage converters 10a, 10b are bidirectional DC-DC converters. Hereinbelow, the voltage converter 10a may be termed a first converter 10a, and the voltage converter 10b may be termed a second converter 10b.

The battery 3 is for example a lithium ion battery. Two voltage converters 10a, 10b are connected in parallel between the battery 3 and the inverter 20. Further, although the voltage converters 10a, 10b are bidirectional DC-DC converters, their battery 3 side will be termed an input end 17 and their inverter 20 side will be termed an output end 18 for simplicity of explanation. Positive and negative electrodes of the input end 17 will be termed an input positive end 17a, and an input negative end 17b, respectively. Positive and negative electrodes of the output end 18 will be termed an output positive end 18a, and an output negative end 18b, respectively.

A system main relay 13 is inserted between the battery 3 and the two voltage converters 10a, 10b. The system main relay 13 is cooperating with a main switch (not shown) of the vehicle. When the main switch (not shown) of the vehicle is turned on, the system main relay 13 closes, and the battery 3 and the two voltage converters 10a, 10b are thereby connected. When the main switch is turned off, the system main relay 13 opens, and the two voltage converters 10a, 10b are cut off from the battery 3.

The first converter 10a and the second converter 10b have a same circuit configuration. The first converter 10a will be described. The first converter 10a comprises a reactor 4a, two transistors 5a, 6a, and two diodes 7a, 8a. The two transistors 5a, 6a are IGBTs (Insulated Gate Bipolar Transistors). The two transistors 5a, 6a are connected in series. A high potential side of the serial connection of the two transistors 5a, 6a is connected to the output positive end 18a, and a low potential side thereof is connected to the output negative end 18b. The output negative end 18b is directly connected to the input negative end 17b. One end of the reactor 4a is connected to the input positive end 17a, and the other end thereof is connected to an intermediate point of the serial connection of the two transistors 5a, 6a. The diode 7a is connected in reverse parallel to the high potential-side transistor 5a of the serial connection, and the diode 8a is connected in reverse parallel to the low potential-side transistor 6a of the serial connection. For the simplicity of the explanation, the high potential-side transistor 5a of the serial connection may be termed an upper arm transistor 5a and the low potential-side transistor 6a thereof may be termed a lower arm transistor 6a.

The second converter 10b comprises two transistors 5b, 6b, a reactor 4b, and diodes 7b, 8b. As can be understood from FIG. 1, the circuit configuration of the second converter 10b is identical to the circuit configuration of the first converter 10a. Thus, its detailed description will be omitted. For the simplicity of explanation, of the two transistors 5b, 6b connected in series, the high potential-side transistor may be termed an upper arm transistor 5b and the low potential-side transistor may be termed a lower arm transistor 6b.

The filtering capacitor 14 is connected between the input positive end 17a and the input negative end 17b. The filtering capacitor 14 is a common capacitor for the two voltage converters 10a, 10b, and it cooperates with the reactors 4a, 4b to temporarily store or discharge electric energy. The smoothing capacitor 15 is connected between the output positive end 18a and the output negative end 18b. The smoothing capacitor 15 is also a common capacitor for the two voltage converters 10a, 10b, and it smoothens out the current flowing from the voltage converters 10a, 10b to the inverter 20.

As described above, the voltage converters 10a, 10b can perform both a step-up operation of boosting the voltage of the battery 3 and supplying the same to the inverter 20, and a step-down operation of lowering the voltage of the regenerated electric power sent from the inverter 20 and supplying the same to the battery 3. The lower arm transistor 6a of the first converter 10a is involved in the step-up operation, and the upper arm transistor 5a thereof is involved in the step-down operation. Similarly, the lower arm transistor 6b of the second converter 10b is involved in the step-up operation, and the upper arm transistor 5b thereof is involved in the step-down operation. The transistors 5a, 5b, 6a, 6b are respectively switched on and off by pulse-width modulation (PWM) signals (drive signals) that are supplied to their gates. The PWM signals that drive the transistors 5a, 5b, 6a, 6b are generated by the controller 9. For simplicity of explanation, the drive signal to be supplied to the upper arm transistor 5a will be termed an A1 drive signal, and the drive signal to be supplied to the lower arm transistor 6a will be termed an A2 drive signal. Similarly, the drive signal to be supplied to the upper arm transistor 5b will be termed a B1 drive signal, and the drive signal to be supplied to the lower arm transistor 6b will be termed a B2 drive signal. “A1”, “A2”, “B1”, and “B2” in the drawings respectively denote the A1 drive signal, the A2 drive signal, the B1 drive signal, and the B2 drive signal.

The electric power supply system 2 further comprises a temperature sensor 12 configured to measure the temperature of the battery 3, and the temperature of the battery 3 measured by the temperature sensor 12 is sent to the controller 9.

In the electric vehicle 100, an accelerator pedal and a brake pedal are alternately stepped on frequently. That is, in the electric vehicle 100, the power running and the regeneration alternately switch frequently. That is, a direction of the current in the first converter 10a switches frequently. Thus, the controller 9 of the electric power supply system 2 supplies the transistors 5a and 6a with complementary drive signals (PWM pulse signals). Specifically, the controller 9 supplies a PWM signal to the upper arm transistor 5a as the A1 drive signal which is reversed a HIGH level and a LOW level of the PWM signal (A2 drive signal) supplied to the lower arm transistor 6a. In so doing, the first converter 10a operates to maintain a ratio between the low voltage-side voltage and the high voltage-side voltage at a constant rate irrelevant to the directions of the current. The same applies to the second converter 10b. That is, the controller 9 supplies the transistors 5b and 6b with complementary drive signals (PWM pulse signals). Specifically, the controller 9 supplies a PWM signal to the upper arm transistor 5b as the B1 drive signal which is reversed a HIGH level and a LOW level of the PWM signal (B2 drive signal) supplied to the lower arm transistor 6b.

The controller 9 supplies the drive signals (A1 drive signal and B1 drive signal) having a same waveform to the upper arm transistors 5a, 5b of the respective voltage converters so that the first converter 10a and the second converter 10b perform a same operation. Similarly, the controller 9 supplies the drive signals (A2 drive signal and B2 drive signal) having a same waveform to the lower aim transistors 6a, 6b of the respective voltage converters. Here, having the same waveform means having a same duty ratio. The controller 9 sets a total output voltage of the voltage converters 10a, 10b according to a stepped amount of the accelerator pedal (not shown), and determines the drive signals to be supplied to the respective transistors, that is, the duty ratios of the PWM signals so that the total output voltage can be obtained. As mentioned above, the duty ratios of the upper arm transistors 5a, 5b are the same, and the duty ratios of the lower arm transistors 6a, 6b are the same.

However, the controller 9 changes phases of the A1 drive signal and the B1 drive signal according to the temperature of the battery 3. Similarly, the controller 9 changes phases of the A2 drive signal and the B2 drive signal according to the temperature of the battery 3. The drive signals, which are the PWM pulse signals, are generated based on signals having a triangular waveform called carrier signals. Thus, the phases of the drive signals to be supplied to the transistors 5a, 6a of the first converter 10a and the drive signals to be supplied to the transistors 5b, 6b of the second converter 10b can be offset by changing phases of the carrier signal for generating the drive signals for the first converter 10a and the carrier signal for generating the drive signals for the second converter 10b.

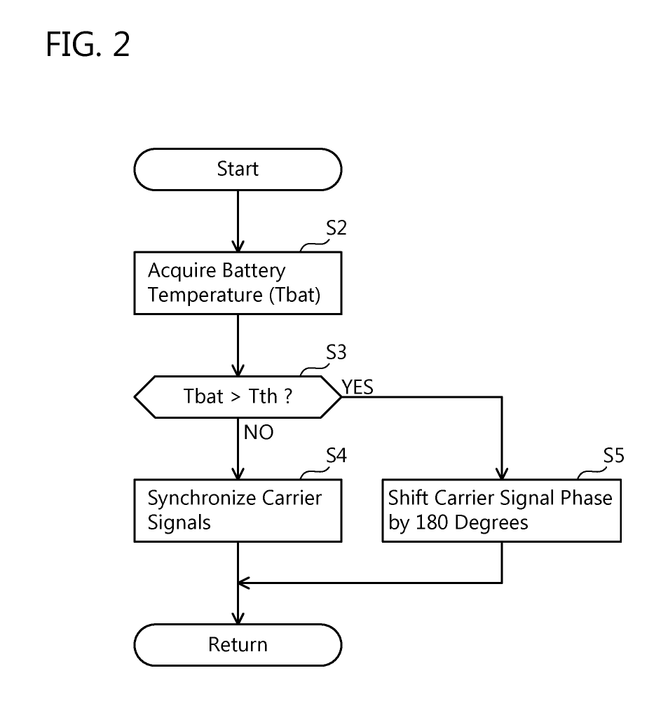

The controller 9 changes the phases of the drive signals supplied to the first converter 10a and the drive signals supplied to the second converter 10b according to the temperature of the battery 3. FIG. 2 shows a flowchart of a phase control of the drive signals executed by the controller 9. The process of FIG. 2 is iterated periodically. The controller 9 firstly acquires the temperature Tbat of the battery 3 (S2). Notably, as described above, the electric power supply system 2 comprises the temperature sensor 12 configured to measure the temperature of the battery 3, and the controller 9 acquires the temperature of the battery 3 from the temperature sensor 12. Next, the controller 9 compares the temperature Tbat of the battery 3 with a threshold temperature Tth (S3). The threshold temperature Tth is set to a value by which the battery 3 can perform its normal function if its temperature is higher than that temperature (threshold temperature Tth). To express it from an opposite view, the performance of the battery 3 is lowered when the temperature Tbat of the battery 3 is lower than the threshold temperature Tth. Notably, in other words, the threshold temperature Tth corresponds to a lower limit value of an appropriate temperature range for using the battery 3. The battery 3 is for example a lithium ion battery, and it is known that an output of the lithium ion battery is lowered when its temperature is low.

When the temperature That of the battery 3 is lower than the threshold temperature Tth (S3: NO), the controller 9 synchronizes the carrier signal for generating the drive signals for the first converter 10a and the carrier signal for generating the drive signals for the second converter 10b (S4). That is, when the temperature Tbat of the battery 3 is lower than the threshold temperature Tth (S3: NO), the controller 9 supplies the drive signals having the same waveform and same phase to the corresponding transistors of the voltage converters 10a, 10b. Notably, the upper arm transistor 5b of the second converter 10b corresponds to the upper arm transistor 5a of the first converter 10a, and the lower arm transistor 6b of the second converter 10b corresponds to the lower arm transistor 6a of the first converter 10a. On the other hand, when the temperature Tbat of the battery 3 is higher than the threshold temperature Tth (S3: YES), the controller 9 offsets the phase of the carrier signal for generating the drive signals for the first converter 10a by 180 degrees from the phase of the carrier signal for generating the drive signals for the second converter 10b (S5). That is, when temperature Tbat of the battery 3 is higher than the threshold temperature Tth (S3: YES), the controller 9 supplies the drive signals having the same waveform but different phases to the corresponding transistors of the voltage converters 10a, 10b

Notably, when the temperature That of the battery 3 is equal to the threshold temperature Tth, which of step S4 or S5 the process proceed to may be set according to desired settings.

Generally, a transistor generates pulse current called ripple upon beginning and ending of a switching operation. When the ripple flows to another device, it may vibrate the device and become a cause of noise therein. Thus, normally the ripple is desirably small. However, in the electric power supply system 2, the ripple is actively used to raise the temperature of the battery 3 when the temperature of the battery 3 is lower than its appropriate range. When drive signals having the same waveform and same phase are supplied to the corresponding transistors of the two voltage converters 10a, 10b (for example, the transistors 5a, 5b), the corresponding transistors turn on at a same timing, and turn off at a same timing. That is, ripples are generated in the corresponding transistors at same timings. Since the transistors of the voltage converters 10a, 10b are electrically connected to the battery 3, the ripples that the corresponding transistors had generated are overlapped, that is, adding up to about a doubled amplitude, and reach the battery 3. The battery 3 generates heat by the ripples with large amplitudes entering into the battery 3, and the temperature thereof rises.

On the other hand, in the case where the temperature Tbat of the battery 3 is higher than the threshold temperature Tth, that is, when the battery 3 does not need to be heated actively, the controller 9 supplies the drives signals having the same waveform but with their phases shifted by 180 degrees to the corresponding transistors of the voltage converters 10a, 10b. The corresponding transistors (for example, the transistors 5a and 5b) generate ripples with their phases shifted by 180 degrees. In doing so, their ripples are cancelled out by each other, and an influence of the ripples to the battery 3 is reduced. Further, since their ripples are cancelled out by each other, noise caused by the ripples can be suppressed. When the battery 3 does not need to be heated actively, the electric power supply system 2 cancels the ripples that the corresponding transistors generate, and suppresses the noise caused by the ripples.

Notably, a ripple is a high frequency pulse component of current, and propagates both upstream and downstream of the current from the transistor irrelevant to directions of a DC component of the current. Thus, overlapped ripples reach the battery 3 by the synchronized drive signals in both the power running and the regeneration. Further, in the case where the controller 9 supplies the synchronized drive signals to the two voltage converters 10a, 10b, the overlapped ripples reach the inverter 20 as well, and the inverter 20 also generates heat. However, a typical case where the temperature of the battery 3 is low is when the main switch of the vehicle is turned on in a cold environment. In such a case, it is very likely that the temperature of the inverter 20 is also low, thus the heat generation in the inverter 20 by the overlapped ripples do not become a problem. The electric power supply system 2 gives priority to heating the battery 3 than the noise suppression or the suppression of the heat generation in the inverter 20 when the temperature of the battery 3 is low, and allows the battery 3 to quickly exhibit the appropriate performance.

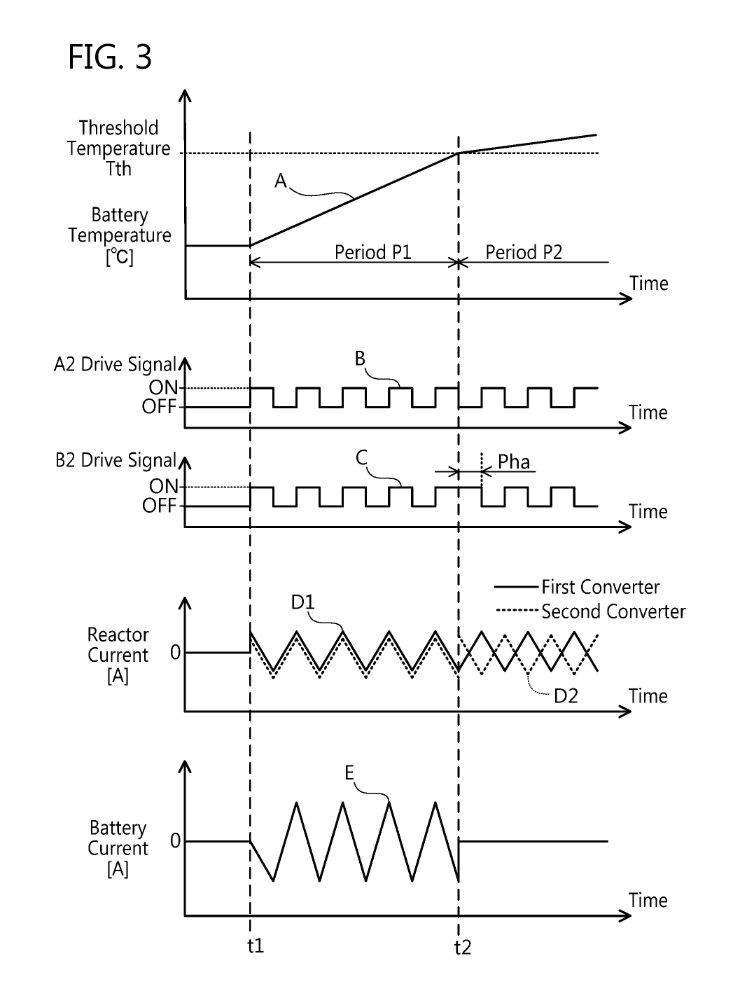

An example of a relationship between the temperature of the battery 3, the drive signals, and the ripples will be described with reference to FIG. 3. FIG. 3 is a time chart, and a graph A shows the temperature of the battery 3. A graph B shows the A2 drive signal, that is, the drive signal supplied to the lower aim transistor 6a of the first converter 10a. A graph C shows the B2 drive signal, that is, the drive signal supplied to the lower arm transistor 6b of the second converter 10b. Graphs D1, D2 show waveforms of ripple currents that flow in the reactors of the respective voltage converters. A solid line (graph D1) shows the ripple current that flows in the reactor 4a of the first converter 10a, and a broken line (graph D2) shows the ripple current that flows in the reactor 4b of the second converter 10b. A graph E shows a waveform of the ripple current that reaches the battery 3. Notably, the graphs D1, D2, E shown only the ripple current, and do not include the DC component of the current. Further, in the graphs D1, D2, the ripple of the second converter 10b (graph D2) is depicted by shifting it slightly lower than the ripple of the first converter 10a (graph D1) for easier understanding. Notably, a period P1 is a period during which the temperature of the battery 3 Tbat is lower than the threshold temperature Tth, and a period P2 is a period during which the temperature of the battery 3 Tbat is higher than the threshold temperature Tth.

At time t1, the main switch of the electric vehicle 100 is turned on, and an entire system of the electric vehicle including the electric power supply system 2 is activated. Upon the system activation, the controller 9 synchronizes the A2 drive signal and the B2 drive signal because the temperature of the battery 3 Tbat is lower than the threshold temperature Tth. That is, the controller 9 supplies the drive signals having the same waveform and same phase (that is, synchronized) to the lower arm transistor 6a of the first converter 10a and the lower arm transistor 6b of the second converter 10b. At this occasion, the ripple current flowing in the reactor 4a of the first converter 10a and the ripple current flowing in the reactor 4b of the second converter 10b come to have the synchronized waveform (graphs D1, D2 in period P1). Thus, the ripple having the larger amplitude by the ripples of the lower arm transistors 6a, 6b being overlapped is inputted to the battery 3 (graph E in period P1). The temperature of the battery 3 is raised quickly by the ripple having the large amplitude.

At time t2, the temperature of the battery 3 exceeds the threshold temperature Tth. After the time t2, the controller 9 shifts the phase of the drive signal (B2 drive signal) to be supplied to the lower arm transistor 6b of the second converter 10b by 180 degrees with respect to the drive signal (A2 drive signal) to be supplied to the lower arm transistor 6a of the first converter 10a. A portion indicated by a reference sign Pha in FIG. 3 shows that the phase of the B2 drive signal (graph C) has been shifted by 180 degrees with respect to the A2 drive signal (graph B). This shift in the drive signals causes the ripple current flowing in the reactor 4b of the second converter 10b to shift its phase by 180 degrees with respect to the ripple current flowing in the reactor 4a of the first converter 10a (graphs D1, D2 in period P2). Thus, the ripple currents generated from the two corresponding transistors (lower arm transistors 6a, 6b) are cancelled, and no influence is imposed on the battery 3 thereby (graph E in period P2). Since the ripple currents cancel each other out, the noise caused by the ripple currents is also suppressed.

Notably, the temperature gradually rises after the time t2 by the continued power output by the battery 3. The temperature of the battery 3 changes according to an increase and a decrease in the power output of the battery 3.

As described above, the drive signal for the upper arm transistor 5a (5b) is a complementary signal of the drive signal for the lower arm transistor 6a (6b). Due to this, when synchronized drive signals having the same waveform are to be supplied to the lower aim transistors 6a, 6b, synchronized chive signals are supplied to the upper arm transistors 5a, 5b. Similarly, when drive signals having the same waveform but different phases are to be supplied to the lower arm transistors 6a, 6b, drive signals having the same waveform but different phases are supplied to the upper arm transistors 5a, 5b.

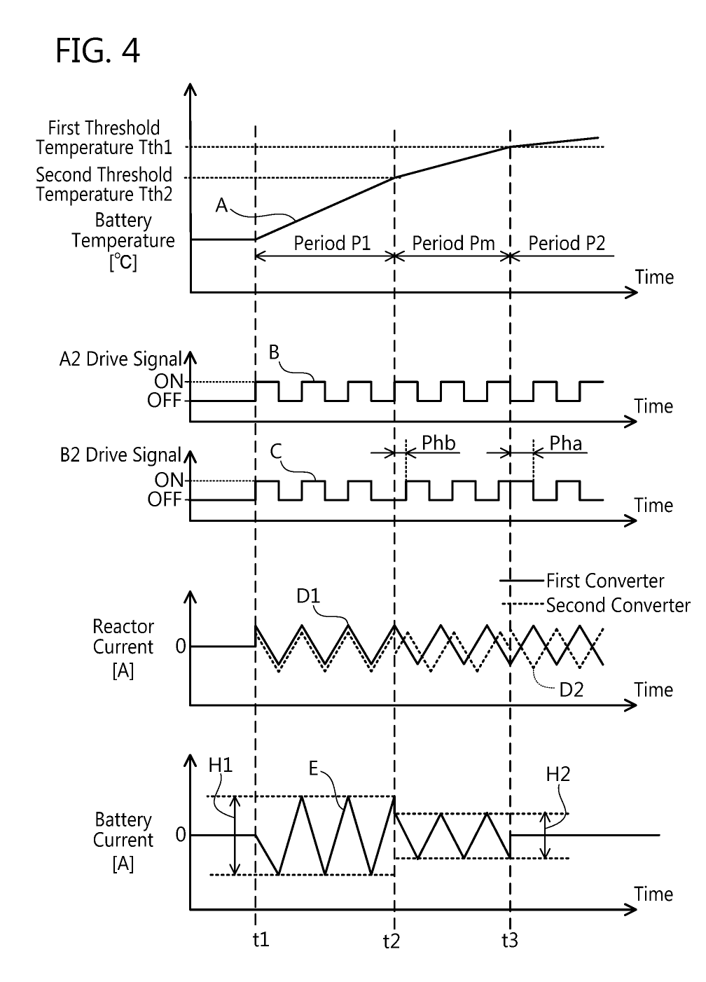

A variant of the phase control will be described. FIG. 4 is a time chart in the phase control of the variant. The graphs A, B, C, D1, D2, E refer to the same things as in FIG. 3. In this variant, the controller 9 stores two types of threshold temperatures (first threshold temperature Th1 and second threshold temperature Th2). Here, the first threshold temperature Th1 is higher than the second threshold temperature Th2. When the temperature of the battery 3 exceeds the first threshold temperature Th1, the controller 9 supplies the drive signals having the same waveform but phases that are shifted by 180 degrees to the lower arm transistors 6a, 6b. In FIG. 4, a portion indicated by a reference sign Pha shows that the phases of the drive signals are shifted by 180 degrees. Further, the period P2 is the period during which the temperature of the battery 3 exceeds the first threshold temperature Th1, thus is a period during which the drive signals with phases shifted by 180 degrees are being supplied.

When the temperature of the battery 3 is lower than the first threshold temperature Th1 but higher than the second threshold temperature Th2, the controller 9 supplies the drive signals having the same waveform but phases that are shifted by 90 degrees to the lower arm transistors 6a, 6b. In FIG. 4, a portion indicated by a reference sign Phb shows that the phases of the drive signals are shifted by 90 degrees. Notably, the phases being shifted by 90 degrees and the phases being shifted by 270 degrees are equivalent in terms of the relative relationship of two drive signals. Further, in this description, the smaller value is employed as the phase difference. In FIG. 4, a period Pm is a period during which the temperature of the battery 3 is lower than the first threshold temperature Th1 but higher than the second threshold temperature Th2, thus is a period during which the drive signals with phases shifted by 90 degrees are being supplied.

When the temperature of the battery 3 is lower than the second threshold temperature Th2, the controller 9 supplies the drive signals having the same waveform and same phases to the lower arm transistors 6a, 6b. In FIG. 4, the period P1 corresponds to a period during which the drive signals having the same phase are being supplied.

The ripple that flows to the battery 3 is largest during when the phases of the drive signals match (period P1), and second largest is during when the phase difference between the drive signals is 90 degrees (period Pm). An amplitude shown by a reference sign H1 in FIG. 4 shows the amplitude of the ripple when the drive signals have the same phase, and an amplitude of a reference sign H2 shows the amplitude of the ripple when the drive signals have the 90-degree phase difference. When the phase difference is 180 degrees, the ripples of the lower arm transistors 6a, 6b of the two voltage converters 10a, 10b are substantially completely cancelled, thus the ripple reaching the battery 3 becomes zero. A rising rate of the temperature of the battery 3 becomes largest in the period P1 when the amplitude of the ripple reaching the battery 3 is the largest, and the rising rate of the temperature of the battery 3 is second largest in a period Pm having a second largest ripple amplitude. In the period P2, there is scarcely any rise in the temperature of the battery 3 caused by the ripples, however, a rise in the temperature of the battery 3 due to using the electric power of the battery 3 can be observed.

The controller 9 executes the following process at around the first threshold temperature Th1 and at around the second threshold temperature Th2. When the temperature of the battery 3 is lower than the predetermined threshold temperature (first threshold temperature Th1 or second threshold temperature Th2), the controller 9 supplies the drive signals, which have the same waveform but have the phase difference that is small as compared to a case where the temperature of the battery 3 is higher than the threshold temperature, to the lower arm transistors 6a, 6b of the two voltage converters 10a, 10b. Especially, when the temperature of the battery 3 is higher than the second threshold temperature Th2, the controller 9 supplies the drive signals having the same waveform but different phases to the lower arm transistors 6a, 6b of the two voltage converters 10a, 10b, and when the temperature of the battery 3 is lower than the second threshold temperature, the controller 9 supplies the drive signals having the same waveform and same phase to the lower arm transistors 6a, 6h.

The features of the electric power supply system of the embodiment are summarized as follows. In the electric power supply system 2, two voltage converters 10a, 10b are connected in parallel between the battery 3 and the inverter 20. Each of the voltage converters 10a, 10b comprises an electric power converting transistor that is electrically connected to the battery 3. The temperature of the battery 3 is measured by the temperature sensor 12. The controller 9 changes the phases of the drive signals to be supplied to the corresponding transistors of the two voltage converters 10a, 10b according to the temperature measured by the temperature sensor 12. The upper arm transistor 5b of the second converter 10b corresponds to the upper arm transistor 5a of the first converter 10a, and the lower arm transistor 6b of the second converter 10b corresponds to the lower arm transistor 6a of the first converter 10a. When the temperature of the battery 3 Tbat is higher than the threshold temperature Tth, the controller 9 supplies the drive signals having the same waveform but having their phases shifted by 180 degrees to the corresponding transistors of the two voltage converters 10a, 10b. The drive signals having the same waveform but having their phases shifted by 180 degrees are typical examples of the drive signals having the same waveform but different phases. When the temperature of the battery 3 Tbat is lower than the threshold temperature Tth, the controller 9 supplies the drive signals having the same waveform and same phase to the corresponding transistors of the two voltage converters 10a, 10b.

In the electric power supply system of the variant, when the temperature of the battery 3 is lower than the predetermined threshold temperature (first threshold temperature Th1 or second threshold temperature Th2), the controller 9 supplies the drive signals, which have the same waveform but have the phase difference that is small as compared to the case where the temperature of the battery 3 is higher than the threshold temperature, to the lower arm transistors 6a, 6b of the two voltage converters 10a, 10b.

Since the drive signals are PWM pulse signals, “signals having the same waveform” means “PWM signals having a same duty ratio”. Thus, the process of the controller 9 as aforementioned may be expressed as follows. When the temperature of the battery 3 is lower than the predetermined threshold temperature (first threshold temperature Th1 or second threshold temperature Th2), the controller 9 supplies the drive signals, which are PWM signals (drive signals) having the same duty ratio and have the phase difference between the PWM signals that is small as compared to the case where the temperature of the battery 3 is higher than the threshold temperature, to the lower arm transistors 6a, 6b of the two voltage converters 10a, 10b. Moreover, when the temperature of the battery 3 is higher than the second threshold temperature Th2, the controller 9 supplies the drive signals having the same duty ratio but different phases between the PWM signals to the lower arm transistors 6a, 6b. When the temperature of the battery 3 is lower than the second threshold temperature, the controller 9 supplies the drive signals having the same duty ratio and same timings for the PWM signals to the lower arm transistors 6a, 6b.

The inverter 20 and the motor 30 of the embodiment correspond to examples of “load apparatus” in the claims. The load apparatus is not limited to inverters and motors. The voltage converters 10a, 10b of the embodiment correspond to an example of “two power converters” in the claims. The power converters are not limited to the voltage converters 10a, 10b of the embodiment. The power converters may be inverters connected to the battery without any voltage converters intervening in between. For example, in an inverter that outputs three-phase alternating current, a circuit that generates alternating current for one of the phases may be facilitated by a parallel connection of two circuits having a same structure. Then, the phases of the drive signals to be supplied to switching elements of the plurality of circuits connected in parallel may be changed according to the temperature of the battery. In this case, the two circuit connected in parallel to generate the alternating current for one of the phases correspond to “two power converters” in the claims.

Further, the technique disclosed herein can suitably be adapted to an electric power supply system that connects three or more power converters in parallel. In this case, the phases of the drive signals for two or more power converters among the three or more power converters may be changed according to the temperature of the battery.

The transistors 5a, 6a, 5b, 6b of the embodiment correspond to examples of “switching elements” in the claims. The “switching elements” are not limited to IGBTs. The “switching elements” in the claims may for example be MOSFETS (Metal Oxide Semiconductor Field Effect Transistors), or other elements.

When each of the power converters comprises a plurality of switching elements, the controller supplies the drive signals having the same waveform to a first transistor of one of the power converters and a transistor in another power converter corresponding to the first transistor. An example of the “drive signals having the same waveform” is the PWM signals having the same duty ratio.

Aside from changing the phases of the carrier signals, the phases of the drive signals may be changed by shifting start trigger timings of the respective cycles of the PWM signals.

While specific examples of the teaching disclosed herein have been described above in detail, these examples are merely illustrative and place no limitation on the scope of the patent claims. The technology described in the patent claims also encompasses various changes and modifications to the specific examples described above. The technical elements explained in the present description or drawings provide technical utility either independently or through various combinations, and are not limited to the combinations described at the time the claims are filed. Further, the purpose of the examples illustrated by the present description or drawings is to satisfy multiple objectives simultaneously, and satisfying any one of those objectives gives technical utility to the disclosed teaching.

What is claimed is:

1. An electric power supply system configured to supply electric power to a load apparatus, the electric power supply system comprising:
a battery;
two or more power converters connected in parallel between the battery and the load apparatus, each of the two or more power converters including a switching element for power conversion, each of the switching elements configured to be electrically connected to the battery;
a temperature sensor configured to measure a temperature of the battery; and
a controller configured to supply drive signals having a same waveform to the switching elements of the two or more power converters,
wherein the controller is configured to change phases of the drive signals for two power converters among the two or more power converters according to the temperature measured by the temperature sensor, and
the controller changes the phases of the drive signals so that a phase difference between the drive signals when the battery temperature is lower than a threshold temperature is set smaller than the phase difference when the battery temperature is higher than the threshold temperature.

2. The electric power supply system of claim 1, wherein the controller is configured to:
supply the drive signals having the same waveform but different phases to the switching elements of the two power converters among the two or more power converters when the battery temperature is higher than the threshold temperature; and
supply the drive signals having the same waveform and a same phase to the switching elements of the two power converters when the battery temperature is lower than the threshold temperature.

3. The electric power supply system of claim 1, wherein the controller is configured to supply the drive signals having the same waveform with a 180-degree phase difference to the switching elements of the two power converters among the two or more power converters when the battery temperature is higher than the threshold temperature.
